(19) United States
(12) Patent Application Publication
(10) Pub. No.: US 2007/0249393 A1
(43) Pub. Date: Oct. 25, 2007

(54) Radiocommunications Device Capable of Operating According to Two Standards

(75) Inventors: Francois Sittler, Thorigne-Fouillard (FR); Jacques Mathe, Penvenan (FR)

Correspondence Address: WESTMAN CHAMPLIN & KELLY, P.A., SUITE 1400, 900 SECOND AVENUE SOUTH, MINNEAPOLIS, MN, 55402-3319, US

(73) Assignee: Wavecom, Issy-Les-Moulineaux Cedex (FR)

(21) Appl. No.: 10/582,200

(22) PCT Filed: Dec. 9, 2004
(86) PCT No.: PCT/FR04/03176

§ 371 Date: Mar. 8, 2007

(30) Foreign Application Priority Data
Dec. 11, 2003 (FR) 0314556

(51) Int. Cl. H04M 1/00

(52) U.S. Cl. 455/553.1

(57) ABSTRACT

The disclosure relates to a radiocommunications device capable of operating on at least two emission frequency bands and at least two reception frequency bands, comprising first means for carrying out communications according to a first predetermined standard. The device also comprises second means for carrying out communications according to a second predetermined standard while using, at least in part, at least one of these frequency bands.

### CROSS-REFERENCE TO RELATED APPLICATION

This Application is a Section 371 National Stage Application of International Application No. PCT/FR2004/003176, filed Dec. 9, 2004 and published as WO 2005/060278 on Jun. 30, 2005, not in English.

### FIELD OF THE DISCLOSURE

The field of the disclosure is that of radiocommunications, and more specifically radiocommunications devices, such as, in particular, cellular telephones.

### BACKGROUND

Radiocommunications techniques are regularly subject to numerous developments and improvements. Thus, to prevent frequency band congestion and to enable cellular telephones to operate in numerous countries, apparatuses capable of operating in a plurality (conventionally two) frequency bands, both for transmission and reception, have been developed.

These apparatuses, known as quadriband cellular telephones, are capable of selecting a frequency band among the two available, depending on the requirements, the network congestion, the geographic area, and so on.

The transmission and reception means must of course be suitable for operating in these different bands.

A disadvantage of cellular telephones is that their operation requires the implementation of a complex and expensive infrastructure (base stations), covering relatively limited geographic areas (cells). In infrequently used areas, such means are generally not implemented. Thus, it is not possible to communicate using a cellular telephone.

For a long time, devices for communication over short distances, called “walkie-talkies”, have been known. These devices operate in analog mode, conventionally by implementing a frequency or amplitude modulation. They use the same frequency band, which requires the link to be a simplex link.

This means that when a user speaks, the other user listens, without responding simultaneously. This technique is called “push to talk”: the user must continuously press on a specific key, activating the transmission function.

These products, while often ineffective (in terms of signal-to-noise ratio or geographic coverage), are advantageous for links over short distances, and in areas not covered by a cellular telephone network.

To be capable of communicating over a long distance, on the one hand, and in areas not covered by a network, on the other hand, an individual must therefore have two separate apparatuses, which is impractical and relatively expensive.

Of course, it is possible to consider combining the two apparatuses in the same casing. However, it would be necessary to juxtapose, in this casing, the digital means specific to the cellular telephone (first standard) and the analog means (second standard). The financial payoff would therefore be low, and the resulting product would be bulky and therefore unergonomic.

Therefore, it is necessary to find a novel and effective solution, enabling two distinct standards to be used simply and effectively in the same radiocommunications device. This requirement is not limited to the case of the walkie-talkie standard. The same problem is encountered in other fields, as will be discussed below.

One or more embodiments of the invention aims to provide a solution to this problem, and to overcome the disadvantages of the prior art.

It should be noted that the formulation of this problem is not obvious per se. Indeed, a person skilled in the art of cellular telephones is not skilled in the art of walkie-talkies, and both consider these to be entirely distinct and independent products, with regard to their technology and implementations as well as their applications.

### SUMMARY

An embodiment of the invention is directed to a radiocommunications device capable of operating on at least two transmission frequency bands and at least two reception frequency bands, including first means for implementing communications according to a first predetermined standard, and second means for implementing communications according to a second predetermined standard, at least partially using at least one of said frequency bands.

Thus, it is possible to make the device operate in a second mode (for example, walkie-talkie mode) in bands that are similar, and/or covering the bands used in the first mode (corresponding to conventional radiocommunications).

According to an advantageous embodiment of the invention, said second communications implementation means use the same frequency band for transmission and reception.

Said frequency band used for transmission and reception is advantageously chosen so as to include a portion in which said device is capable of transmitting according to a first standard and a portion in which it is capable of receiving according to said first standard.

Said first and second communications implementation means share at least some of their processing means.

Said shared processing means can in particular belong to the group including:

digital processing means;

filtering means;

amplification means;

modulation and/or demodulation means.

According to an advantageous feature of an embodiment of the invention, said shared processing means include digital processing means and storage means, containing data for command and control of said digital processing means, according to said first standard and according to said second standard.

In a first advantageous embodiment of the invention, said command and control data for said second standard provide the implementation of digital communications.

According to a second advantageous embodiment, said command and control data for said second standard provide a simulation of analog communications.

Said first predetermined standard can belong in particular to the group including GSM, GPRS and UMTS. Said second standard can belong to the group including a walkie-talkie-type technique or the “Bluetooth” standard.

According to an advantageous implementation of an embodiment of the invention, said transmission frequency bands are 825-849 MHz and 880-915 MHz, and said reception frequency bands are 869-894 MHz and 925-960 MHz.

In this case, the frequency band used by said second communications implementation means can be 868-870 MHz, for transmission and reception, or 902-928 MHz.

The device of an embodiment of the invention preferably includes user-system interface elements specific to the implementation of communications according to said second standard.

Other features and advantages will become clearer from the following description of a preferred embodiment of the invention, given by way of a simple illustrative and non-limiting example, and the appended drawings.

### BRIEF DESCRIPTION OF THE DRAWINGS

FIGS. 1A and 1B are two simplified diagrams showing the general principle of an embodiment of the invention, according to the two distinct standards;

FIGS. 2 is a simplified synoptic diagram of the radiocommunications device according to an embodiment of the invention;

FIGS. 3A and 3B show two examples of the use of frequency bands according to an embodiment of the invention, adapted to Europe and the US, respectively.

### DETAILED DESCRIPTION OF ILLUSTRATIVE EMBODIMENTS

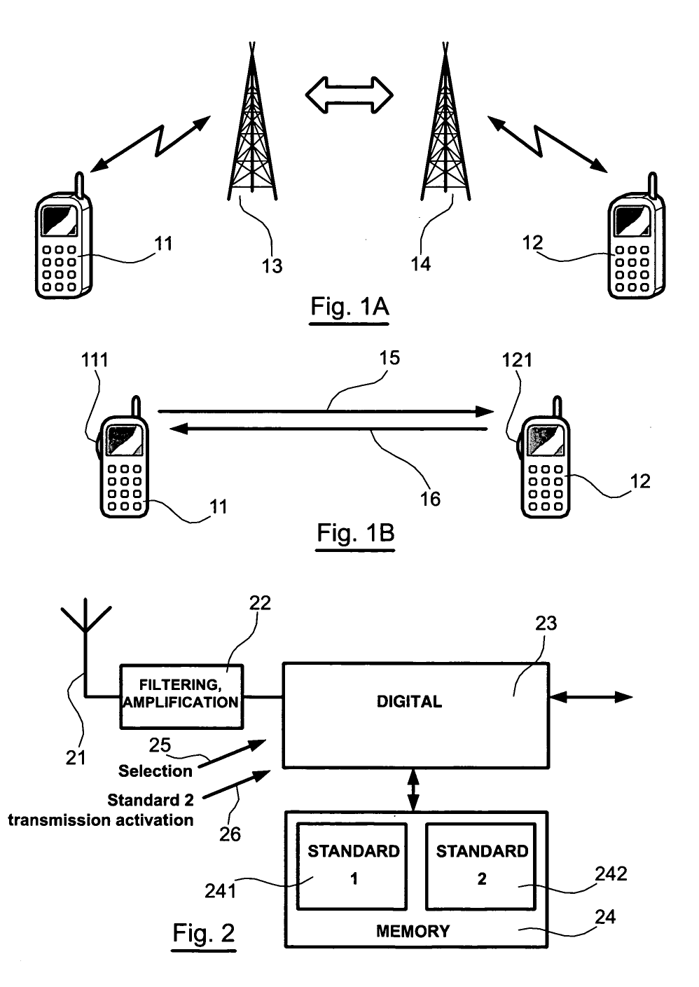

An embodiment of the invention therefore presents a new approach to radiocommunications devices, in particular mobile telephones, implementing at least two standards. In the specific embodiment described below, these two standards are a radiocommunications standard (for example, GSM), as shown diagrammatically in FIG. 1A. The second standard is a walkie-talkie-type standard (also called “push-to-talk”) as shown in figure 1B.

An embodiment of the invention therefore does not relate to cellular telephones implementing two concurrent cellular radiocommunications techniques, but a cellular telephone also providing another type of service (called the second standard). This second service can be of the walkie-talkie type, but also of the “Bluetooth” or “WiFi” type (registered trademarks).

According to an embodiment of the invention, two independent assemblies, dedicated to of the standards, and each operating on its predefined frequency band, are not combined in the same apparatus. On the contrary, the processing means are simplified, thus providing synergy on the frequency bands used.

More specifically, the second standard at least partially uses the frequency bands used according to the first standard. Thus, an advantage is obtained with regard to the location of the frequency bands, which are a scarce resource, and, as will be seen below, the cellular telephone, which can share many of these means between the two standards, is simplified.

As shown in FIG. 1A, a cellular telephone 11 according to an embodiment of the invention can of course communicate conventionally with another cellular telephone 12, according to a first GSM-, GPRS- or UMTS-type standard, for example. The full-duplex communications conventionally travels through the base stations 13 and 14, in which the two cellular telephones 11 and 12 in communication are respectively located.

According to an embodiment of the invention, and as shown in FIG. 1B, the cellular telephones 11 and 12 can also communicate according to a second standard, and be used as conventional walkie-talkies.

The exchange of data thus occurs directly (without passing through the base stations) and generally in a unidirectional manner (the communication takes place in a single direction 15 or 16 at a given time). The cellular telephones 11 and 12 may be equipped with a specific button 111, 121, enabling the user to “take over” and to transmit while this button is pressed down.

This second operation mode can be used in particular for communications over short distances, for example less than two kilometres. It therefore has applications, for example, in the fields of recreation, sporting activities, surveillance, and so on, in particular in locations where there is no coverage according to the first standard.

According to the second standard, there is generally no quality of service concept. However, this second standard has the advantage of being free.

FIG. 2 shows in a very diagrammatic manner, the general principle of a cellular telephone 11 or 12 according to an embodiment of the invention. It includes a single antenna 21 (since, in both cases, common frequency bands, then, as the case may be, analog means 22 for filtering and amplification, are used).

The device also includes digital processing means 23, which conventionally perform encoding/decoding, modulation/demodulation operations, and so on, according to the GSM standard. The data enabling the command and control of these digital processing means 23 are stored in a first portion 241 of a memory 24.

According to an embodiment of the invention, these same digital processing means 23 can also be controlled so as to operate according to the second standard. To do this, command and control instructions are also stored in the memory 24, in a portion 242 thereof.

Thus, a conventional cellular telephone is not, or is minimally, modified with regard to the equipment. Only a specific software portion has had to be developed. Therefore, there is no significant additional equipment cost or increase in complexity.

The user-system interface has simply been slightly adjusted so as to allow for the selection 25 of one or the other of the standards, and the activation 26 of the transmission according to the second standard, for example by a button 111, 121. The selection 25 can be performed manually, automatically, or semi-automatically. For example, it is possible for the terminal first to attempt to implement the second standard, then the first, if it could not reach its correspondent. It is also possible for these steps to be implemented only when attempting to connect to a predetermined terminal 12.

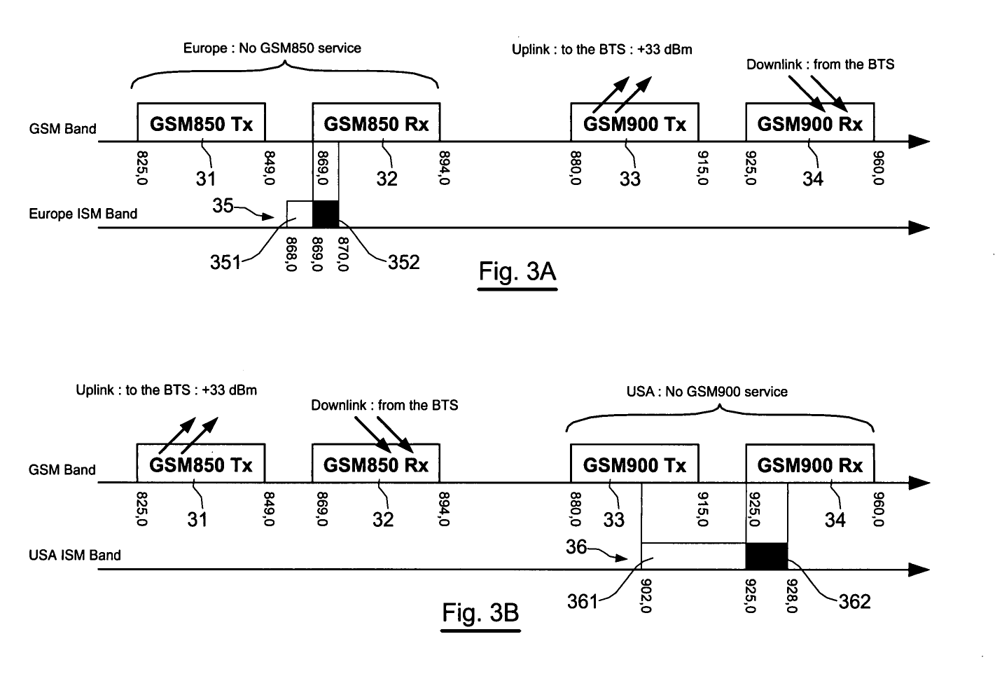

FIGS. 3A and 3B show two examples for the use of the frequency band, suitable for a GSM quadriband cellular telephone, in Europe (FIG. 3A) and in the US (FIG. 3B).

Quadriband cellular telephones are provided to offer two services GSM850 and GSM9000. GSM850 is not used in Europe, while GSM900 is not used in the US.

The bands reserved are therefore the following:

31: GSM850 TX band for transmission: 825.0 to 849.0 MHz;

32: GSM850 RX band for reception: 869.0 to 880.0 MHz;

33: GSM900 TX band for transmission: 880.0 to 915.0 MHz;

34: GSM900 RX band for reception: 925.0 to 960.0 MHz.

It is noted that the GSM850 band intersects, in Europe, with the so-called ISM (Industrial Scientific Medical) band 35 (a band reserved for industrial, scientific and medical applications), which extends from 868 to 870 MHz. It is therefore possible to use this frequency band 35 for the second standard.

The portion 352 extending from 869.0 to 870.0 MHz coincides with the reception band 32. The cellular telephone is therefore capable of operating in reception in this band. In addition, current cellular telephones are capable of transmitting over a wide transmission range extending from 825.0 to around 930 MHz, so as to encompass in particular the two bands 31 and 33. Therefore, they are in particular capable of transmitting in the band 351 extending from 868.0 to 869.0 MHz.

Therefore the band 35 can easily be used for transmission and reception (in walkie-talkie or “push-to-talk” mode, the transmission and reception occur on the same frequency band).

As noted in FIG. 3B, the same reasoning can be applied to the US. The ISM band 36 extends between 902.0 and 928.0 MHz. This band encompasses a portion 362, extending between 925.0 and 928.0 MHz in which the cellular telephone is capable of receiving, and a band 361, between 902.0 and 925.0 MHz, in which the cellular telephone is capable of transmitting. Again, it is therefore possible to implement the second standard on this frequency band 36.

Therefore, it is noted again that it is possible to make the cellular telephone operate according to both standards, with the same digital processing means 23, when they are adapted to the first standard. This first standard implements a digital modulation, for example of the GMSK type.

As regards the second standard, two possibilities can be considered. According to a first approach, the second standard can also implement a digital transmission, which may be identical, or very similar, to that used by the first standard. This approach has the advantage of being simpler, since most digital processing means 23 are used identically or similarly in both operating modes. This also makes it possible to offer good transmission quality, and, as the case may be, specific services (for example, caller identification). However, this approach requires the two users to have the same type of cellular telephone, and therefore is incompatible with apparatuses already available on the market.

Therefore, it is also possible to provide an approach making it possible to ensure, at least in part, this compatibility, consisting of digitally simulating an analog transmission and reception, using digital processing means 23. An example of an algorithm enabling this function to be provided is described in the article “Implementation of FM demodulator algorithms of a high performance digital signal processor” by Franz Schnyder and Christoph Haller.

It is thus possible to simply and effectively add a new service to a cellular telephone, for example of the GSM type, without requiring new frequency bands to be allocated, and without increasing the complexity of the cellular telephones (with the exception of software development).

This approach makes it unnecessary for the telephone operators to install base stations in non-lucrative locations (canyons, forests, areas with a low population density).

It also provides a marketing advantage, as the functionality corresponding to the second standard can be part of a batch of offers. In addition, this approach will lead a client to purchase two cellular telephones, so as to be capable of communicating in the second mode.

The client will also enjoy savings, since he or she is not required to purchase a second walkie-talkie-type apparatus in order to communicate according to the second standard. In addition, the solution is more ergonomic, since the client needs to carry only one terminal instead of two.

An embodiment of the invention provides a technique enabling two entirely different standards, such as a radiocommunications standard and a walkie-talkie standard, to be implemented effectively.

Thus, an embodiment of the invention provides such a technique enabling radiocommunications devices to be produced at a reasonable cost, of which the bulk and ergonomics are acceptable.

An embodiment of the invention provides such a technique that does not require new frequency bands to be allocated.

An embodiment also aims to provide such a technique, allowing for conventional communications, without adaptation, at least according to one of the standards.

An embodiment of the invention provides such a technique, enabling a telephone operator to offer new services in a simple manner, without the need to develop an extensive or complex infrastructure.

Although the present invention has been described with reference to preferred embodiments, workers skilled in the art will recognize that changes may be made in form and detail without departing from the spirit and scope of the invention.

1. A radiocommunications device capable of operating on at least two transmission frequency bands and at least two reception frequency bands, the device comprising:
first means for implementing communications according to a first predetermined standard, and
second means for implementing communications according to a second predetermined standard, at least partially using at least one of said frequency bands.

2. The radiocommunications device according to claim 1, wherein said second communications implementation means use the same frequency band for transmission and reception.

3. The radiocommunications device according to claim 2, wherein said same frequency band used for transmission and reception is chosen so as to include a portion in which said device is capable of transmitting according to said first standard and a portion in which it is capable of receiving according to said first standard.

4. The radiocommunications device according to, claim 1 wherein said first and second communications implementation means comprise at least some shared processing means.

5. The radiocommunications device according to claim 4, wherein said shared processing means belong to the group including:
digital processing means;
filtering means;
amplification means; and
modulation and/or demodulation means.

6. The radiocommunications device according to claim 4, wherein, said shared processing means include digital processing means and storage means, containing data for command and control of said digital processing means, according to said first standard and according to said second standard.

7. The radiocommunications device according to claim 6, wherein said command and control data for said second standard implement digital communications.

8. The radiocommunications device according to claim 6, wherein said command and control data for said second standard simulate analog communications.

9. The radiocommunications device according to claim 1, wherein said first predetermined standard belongs to the group including GSM, GPRS and UMTS.

10. The radiocommunications device according to claim 1, wherein said second standard belongs to the group including a walkie-talkie-type technique or the “Bluetooth” standard.

11. The radiocommunications device according to claim 1, wherein said transmission frequency bands are 825-849 MHz and 880-915 MHz, and in that said reception frequency bands are 869-894 MHz and 925-960 MHz.

12. The radiocommunications device according to claim 11, wherein the frequency band used by said second communications implementation means is 868-870 MHz, for transmission and reception.

13. The radiocommunications device according to claim 11, wherein the frequency band used by said second communications implementation means is 9902-928 MHz, for transmission and reception.

14. The radiocommunications device according to claim 1, wherein it includes user-system interface elements specific to the implementation of communications according to said second standard.

15. A radiocommunications device comprising:
at least two transmission frequency bands;
at least two reception frequency bands;
a single antenna; and
a shared digital processor, which implements communications through the single antenna according to a first predetermined standard and implements communications through the single antenna according to a second predetermined standard, at least partially using at least one of said frequency bands.

16. The radiocommunications device of claim 15, wherein the shared digital processor uses the sane frequency band for transmission and reception to implement communications according to the second predetermined standard, and wherein the same frequency band is chosen so as to include a portion in which the device is capable of transmitting according to the first standard and a portion in which the device is capable of receiving according to the first standard.

17. The radiocommunications device of claim 15 and further comprising:
a storage device containing data for command and control data of the digital processor, according to the first standard and according to the second standard.

18. The radiocommunications device according to claim 17, wherein the command and control data for said second standard implement digital communications.

19. The radiocommunications device according to claim 17, wherein the command and control data for the second standard simulate analog communications.
